(19) United States
(12) Patent Application Publication
(10) Pub. No.: US 2008/0240236 A1
(43) Pub. Date: Oct. 2, 2008

(54) Information processing apparatus

(75) Inventors: Kosuke Uchida, Tokyo (JP); Katsuhisa Yano, Tokyo (JP); Noriaki Kitada, Tokorozawa-shi (JP); Satoshi Hoshina, Tokyo (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 11/896,865

(22) Filed: Sep. 6, 2007

(30) Foreign Application Priority Data
Mar. 30, 2007 (JP) 2007-094910

(51) Int. Cl. H04B 1/66

(52) U.S. Cl. 375/240.03; 375/E07.209

(57) ABSTRACT

An information processing apparatus is for decoding a video encoded sequence and includes: a CPU that decodes the video encoded sequence by executing software; a GPU that decodes the video encoded sequence; a main memory that temporarily stores data for the decoding process performed by the CPU; and a VRAM that temporarily stores data for the decoding process performed by the GPU, wherein the GPU continues the decoding process of subsequent pictures of at least the second and third pictures after the GPU decoded the referenced third picture, until the refresh first picture is subjected to the decoding process.

### CROSS-REFERENCE TO RELATED APPLICATIONS

This application is based upon and claims the benefit of priority from Japanese Patent Application No. 2007-094910, filed on Mar. 30, 2007, the entire contents of which are incorporated herein by reference.

### BACKGROUND

1. Field

One embodiment of the invention relates to an information processing apparatus; for instance, a PC (Personal Computer) or the like.

2. Description of the Related Art

Recently, a number of pieces of information processing apparatus is increasing, the information processing apparatus being, for example, a PC (Personal Computer) or the like, which can decode a video sequence encoded in conformance with an encoding scheme such as H.264/AVC (hereinafter also referred to simply as “H.264”) or the like. However, decoding of a video encoded sequence requires a large amount of computation power. Hence, when a CPU (Central Processing Unit) performs all processing operations required for the video decoding, an influence on other processing becomes high. For this reason, a conceivable idea is to cause a custom-designed GPU (Graphics Processing Unit) to decode a video encoded sequence (see, e.g., JP-A-2006-319944). Several ways to share tasks between the CPU and the GPU are conceivable. In the document JP-A-2006-319944, there is described a technique for dividing a picture into slices, causing a CPU to perform decoding operation including variable-length decoding and reverse quantization of the slices, and causing a GPU to perform decoding operation including inverse discrete cosine transform; namely, a technique for sharing decoding of one picture between the CPU and the GPU.

When a GPU performs decoding operation, the GPU exhibits superiority or inferiority in terms of the nature of processing. Therefore, it may be the case that a CPU performs processing faster than the GPU does. In order to address such a situation, switching between the processors to be used for decoding operation on a per-picture basis is conceivable.

When the CPU performs decoding, main memory is usually used as a storage medium. Further, when the GPU performs decoding, VRAM (Video Random Access Memory) is usually used as a storage medium. However, in a case where transfer of data between the system memory and the VRAM involves consumption of much time; especially, where transfer of data from the VRAM to system memory involves consumption of much time, a delay arises in decoding operation when a reference is made to the picture decoded by the GPU during the course of decoding operation of the CPU.

### SUMMARY

According to one aspect of the present invention, there is provided an information processing apparatus for decoding a video encoded sequence, wherein the video encoded sequence includes: a first picture that is decodable without referring to other picture; a second picture that is decodable by referring to one other picture; and a third picture that is decodable by referring to a plurality of other pictures, wherein the first picture includes a refresh first picture involving resetting of a buffer memory, wherein the third picture includes a referenced third picture that is referred to by the second picture or the third picture and an unreferenced third picture that is referred to by none of other pictures, wherein the information processing apparatus includes: a CPU that decodes the video encoded sequence by executing software; a GPU that decodes the video encoded sequence; a main memory that temporarily stores data for the decoding process performed by the CPU; and a VRAM that temporarily stores data for the decoding process performed by the GPU, wherein the GPU continues the decoding process of subsequent pictures of at least the second and third pictures after the GPU decoded the referenced third picture, until the refresh first picture is subjected to the decoding process.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing a configuration of a computer according to an embodiment of the present invention;

FIG. 2 is a view showing a configuration of a decoding program according to the embodiment;

FIG. 3 is a view showing a hierarchical structure of a video encoded sequence to be decoded by the computer;

FIG. 4 is a view for describing a reference relationship between pictures of the video encoded sequence to be decoded by the computer;

FIG. 5 is a view showing the hierarchical structure of a video encoded sequence to be decoded by the computer;

FIG. 6 is a view showing a type of slice_type of the video encoded sequence to be decoded by the computer;

FIG. 7 is a view showing the hierarchical structure of a video encoded sequence to be decoded by the computer;

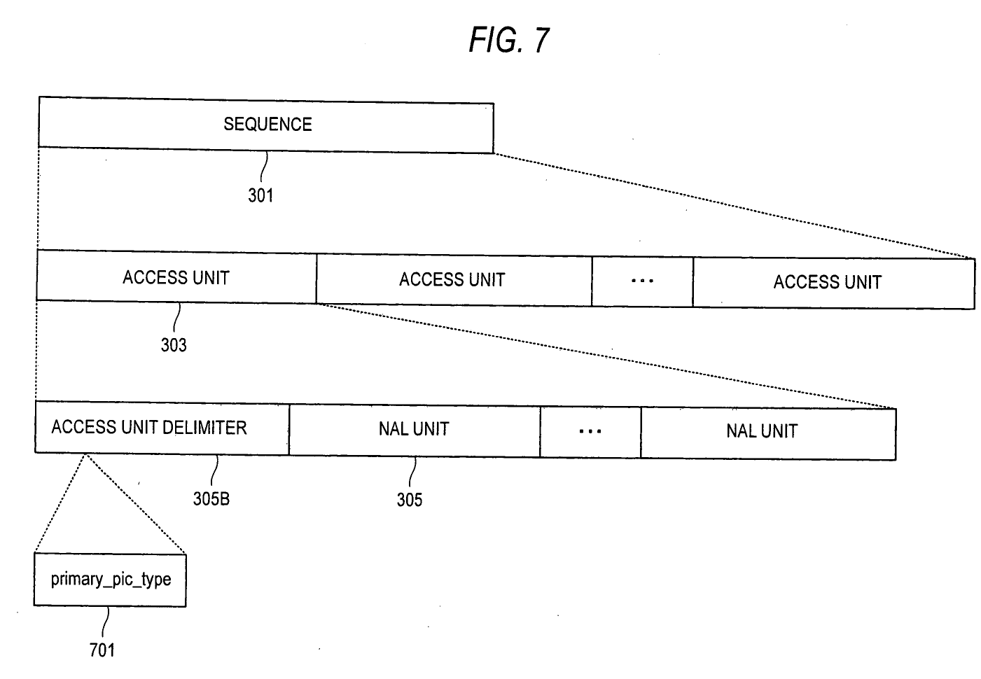

FIG. 8 is a flowchart showing a flow of decoding operation performed by the computer;

FIG. 9 is a flowchart showing a flow of decoding operation performed by the computer;

FIG. 10 is a flowchart showing a flow of decoding operation performed by the computer; and

FIG. 11 is a view showing the hierarchical structure of a video encoded sequence to be decoded by the computer.

### DETAILED DESCRIPTION

An information processing apparatus according to the present invention will be described hereunder by reference to the drawings.

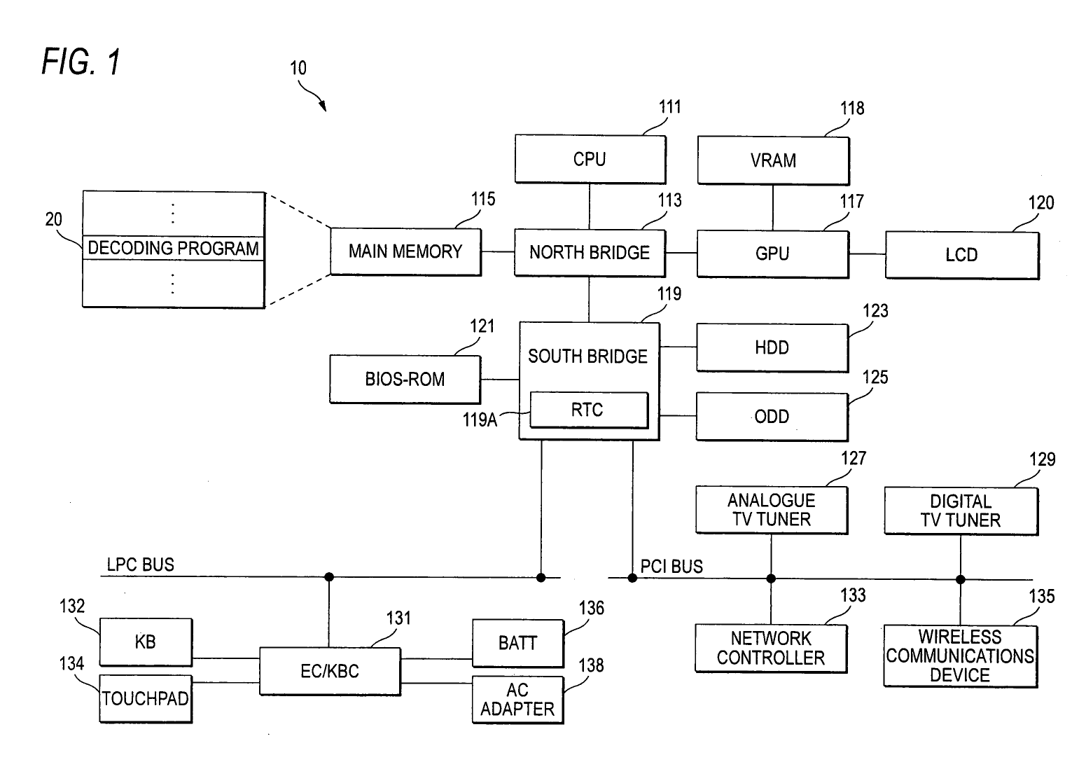

A configuration of a computer according to an embodiment as the information processing apparatus of the present invention will be described by reference to FIG. 1. FIG. 1 is a view showing a configuration of the computer according to the embodiment.

As shown in FIG. 1, a computer 10 includes a CPU 111; a north bridge 113; main memory 115; a graphical processing unit (GPU) 117; VRAM 118; a south bridge 119; BIOS-ROM 121; a hard disk drive (HDD) 123; an optical disk drive (ODD) 125; an analogue TV tuner 127; a digital TV tuner 129; an embedded controller/keyboard controller IC (EC/KBC) 131; a network controller 133; a wireless communications device 135; and the like.

The CPU 111 is a processor provided for controlling operation of the computer 10, and executes various programs, such as an operating system (OS), a decoding program 20, and the like, loaded from the HDD 123 to the main memory 115. The decoding program is for decoding a video sequence encoded in conformance with an encoding scheme; for example, H.264/AVC (hereinafter also referred to simply as “H.264”) or the like. Conceivable encoded video strings to be decoded by the decoding program 20 include; for instance, a sequence loaded from an HD-DVD (High-Definition Digital Versatile Disk) into the ODD 125 and a sequence received by the digital TV tuner 129.

The decoding program 20 is provided for performing decoding operation by means of switching, on a per-picture basis, between a case where the CPU 111 performs decoding (hereinafter also called “decode”) while using the main memory 115 as memory and a case where the GPU 117 performs decoding while using the VRAM 118 as memory. The way to effect switching will be described later.

The CPU 111 executes a BIOS (Basic Input Output System) stored in the BIOS-ROM 121, as well. The BIOS is a program for controlling hardware.

The north bridge 113 is for connecting a local bus of the CPU 111 with the south bridge 119. A memory controller for controlling an access to the main memory 115 is also stored in the north bridge 113. The north bridge 113 also has the function of establishing communication with the CPU 117 through an AGP (Accelerated Graphics Port) bus, or the like.

The GPU 117 is a display controller for controlling an LCD (Liquid-Crystal Display) 120 used as a display monitor of the computer 10. This GPU 117 displays on the LCD 120 image data written in the VRAM 118 by means of the OS or the like. The GPU 117 also has the function of decoding a video encoded sequence under the control of the decoding program 20.

The south bridge 119 controls devices connected to an LPC (Low Pin Count) bus and devices connected to a PCI (Peripheral Component Interconnect) bus. The south bridge 119 incorporates an IDE (Integrated Drive Electronics) for use in controlling the HDD 123 and the ODD 125.

The south bridge 119 has a real time clock (RTC) 119A. The RTC 119A acts as a timer module for counting a current time (Year, Month, Day, Hour, Minute, Second).

The analogue TV tuner 127 and the digital TV tuner 129 serve as a receiving section for receiving broadcast data aired over respective broadcast waves. In the present embodiment, the analogue TV tuner 127 is formed from an analogue TV tuner for receiving broadcast data aired over an analogue broadcast signal. The digital TV tuner 129 is formed from a digital TV tuner for receiving broadcast data aired over a terrestrial digital broadcast signal.

The EC/KBC 131 is a one-chip microcomputer into which an embedded controller for power management and a keyboard controller for controlling the keyboard (KB) 132 and the touch pad 135 are integrated. The EC/KBC 131 has the function of activating/deactivating power of the computer 10 in response to user's operation of a power button. Operation power supplied to individual components of the computer 10 is generated by a battery 136 incorporated in the computer 10 or from external power supplied with from the outside through an AV adapter 138.

The network controller 133 is a device for acquiring a connection with a wired network and used for establishing communication with an external network such as the Internet and the like. Moreover, the wireless communications device 135 is a device for making a connection with a wireless network and used for establishing one-to-one radio communication with another wireless communications device, communication with an external network such as the Internet or the like, and like communication.

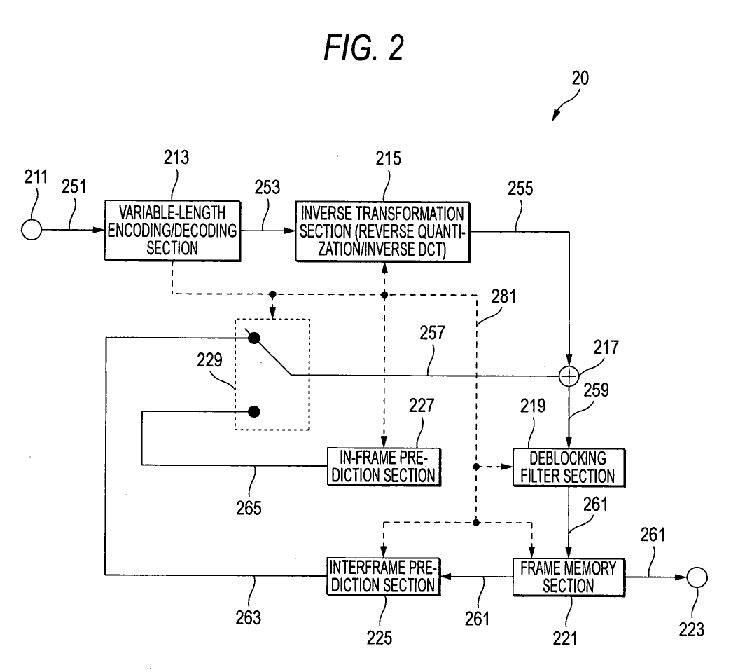

Next, the configuration of the decoding program 20 will be described by reference to FIG. 2. FIG. 2 shows the configuration of the decoding program 20 for decoding a video encoded sequence conforming to the H.264/AVC standard. As mentioned previously, the decoding program 20 shown in FIG. 2 performs decoding in the CPU 111 and the GPU 117.

A video encoded sequence 251 is input through an input terminal 211. The video encoded sequence 251 is output to a variable-length code decoding section 213. The video encoded sequence 251 has already undergone variable-length encoding which reduces the number of bits to be transferred by means of expressing information having a high frequency of appearance in short codes and other information in long codes. The variable-length code decoding section 213 decodes the video sequence 251 having undergone variable-length encoding into quantized DCT coefficient data 253. The variable-length code decoding section 213 also analyzes various pieces of parameter information, such as motion vector information, prediction mode information, and the like, acquired as a result of variable-length decoding of the video encoded sequence 251. Various control signals 281 acquired through analysis processing are imparted, as necessary, to respective configurations of the decoding program 20.

A quantized DCT coefficient data 253 output from the variable-length code decoding section 213 are input to an inverse transformation section 215. The inverse transformation section 215 decodes the quantized DCT coefficient data 253 into a prediction error signal 255 through reverse quantization and Inverse DCT transformation (Inverse Discrete Cosine Transform).

An adder 217 adds the prediction error signal 255 decoded by the inverse transformation section 215 to a predicted image signal 257, whereby the image signal is reproduced as a decoded image signal 259. Block distortion in this decoded image signal 259 is reduced by a deblocking filter section 219. An output image signal 261 whose block distortion has been reduced is output/stored to and in a frame memory section 221 and output from an output terminal 223 in accordance with a predetermined output sequence.

An interframe prediction section 225 performs a correction to the output image signal stored in the frame memory section 221 in accordance with the information acquired as a control signal 281. More specifically, a motion correction is made to the output image signal by use of motion vector information acquired as the control signal 281, and the predicted image signal having undergone motion correction is subjected to weighted prediction through use of a brightness weighting coefficient acquired as the control signal 281. An interframe prediction signal 263 acquired through these interframe prediction processing operations is output from an interframe prediction section 225.

When encoding is effected in an interframe prediction mode, an in-frame prediction section 227 generates and outputs an in-frame prediction signal 265 from the control signal 281.

A switch 229 switches between the interframe prediction signal 263 and the in-frame prediction signal 265 to send any one of them as a predicted image signal to the adder 217, in accordance with the prediction mode information acquired as the control signal 281.

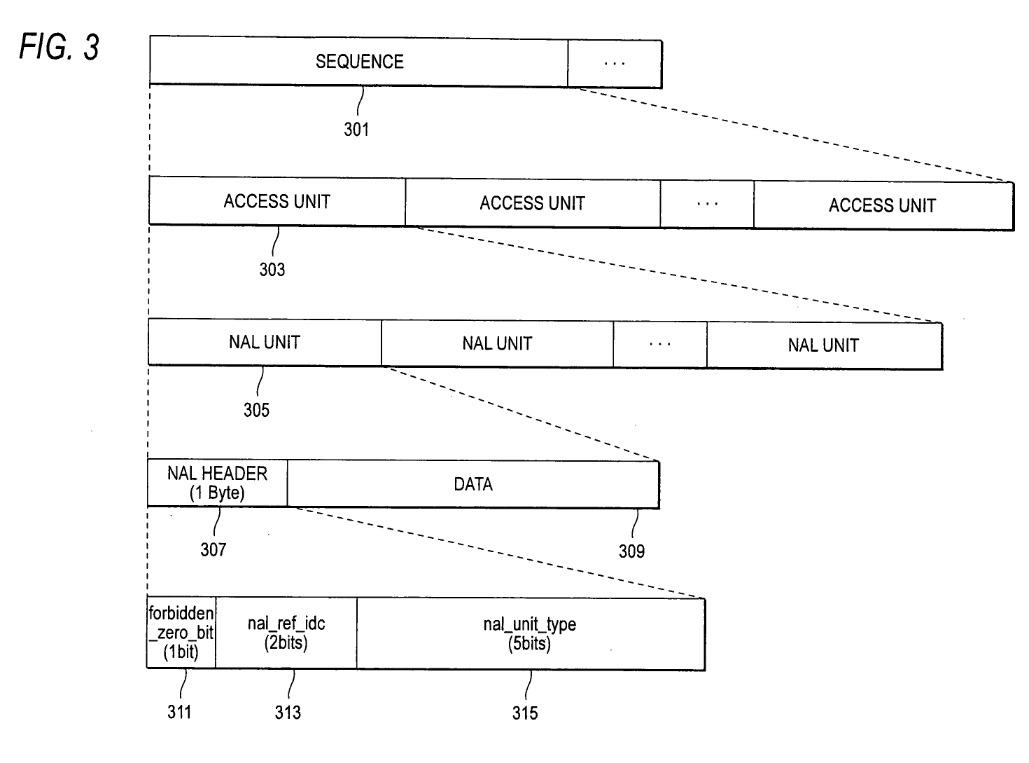

Subsequently, a hierarchical structure of the video encoded sequence 251 which conforms to H.264 standard and is to be decoded by the decoding program 20 will be described by reference to FIG. 3. FIG. 3 is a view showing a hierarchical structure of the video encoded sequence 251.

The video encoded sequence 251 is expressed as a sequence 301. The sequence 301 may also be in the number of two or more. One sequence 301 includes one or a plurality of access units 303. One access unit includes a plurality of NAL (Network Abstraction Layer) units 305.

The NAL unit is broadly classified into a VCL NAL unit for storing video encoded data generated from a video coding layer (a layer to be subjected to video encoding operation; hereinafter simply as “VCL”) and a non-VCL NAL unit for storing various parameter sets, such as an SPS (Sequence Parameter Set), a PPS (Picture Parameter Set), and the like. Herein, the NAL is a layer existing between a video-coding layer and a low-level layer through which encoded information is transferred or accumulated; and is for associating the VCL with a low-level system.

The NAL unit 305 includes a one-byte NAL header 307 and an RBSP (Raw Byte Sequence Payload: simply data 309 in FIG. 3) where information acquired over the VCL is stored.

The NAL header 107 includes a 1-bit forbidden_zero_bit 311 (including a fixed value of 0), a 2-bit nal_ref_idc 313, and 5-bit nal_unit_type 315. The type of the NAL unit can be determined by means of the nal_unit_type 315. Further, the nal_ref_idc 313 is a flag showing whether or not a picture is a referenced picture. The decoding program 20 determines whether a picture being processed is a referenced picture or an unreferenced picture, by means of determining whether or not nonzero is achieved by reference to the nal_ref_idc 313, to thus switch whether to cause the GPU 117 to perform decoding operation or the CPU 111 to perform decoding operation. Details of processing will be described later.

The referenced picture is a picture used as a reference image when another picture is subjected to interframe prediction. Likewise, the unreferenced picture is a picture which is not used as a referenced picture when another picture is subjected to interframe prediction.

Workload of an H.264 CODEC is greater than that of a related-art CODEC such as an MPEG-2 or the like. Therefore, when the computer 10 decodes the H.264 video code sequence 251, decoding is usually performed by utilization of the GPU 117. However, the GPU 117 exhibits superiority or inferiority according to specifics of processing. It may be the case where the CPU 111 performs processing faster than the GPU 117 does. In the present embodiment, a processor which performs processing is adaptively switched on a per-picture basis, thereby preventing occurrence of a delay in decoding operation.

When there is used either the CPU 111 or the GPU 117 which is most appropriate for processing of interest, consideration must be given to a memory area used for decoding operation. In relation to decoding of an H.264 video code sequence or the like, there may arise a case where decoding is performed by reference to a picture decoded in the past. When the GPU 117 performs decoding, the VRAM 118 is used as a storage medium for temporarily storing the output image signal 261; in other words, the frame memory section 221. In contrast, when the CPU 111 performs decoding, the main memory 115 is used as a storage medium for temporarily storing the output image signal 261; in other words, the frame memory section 221.

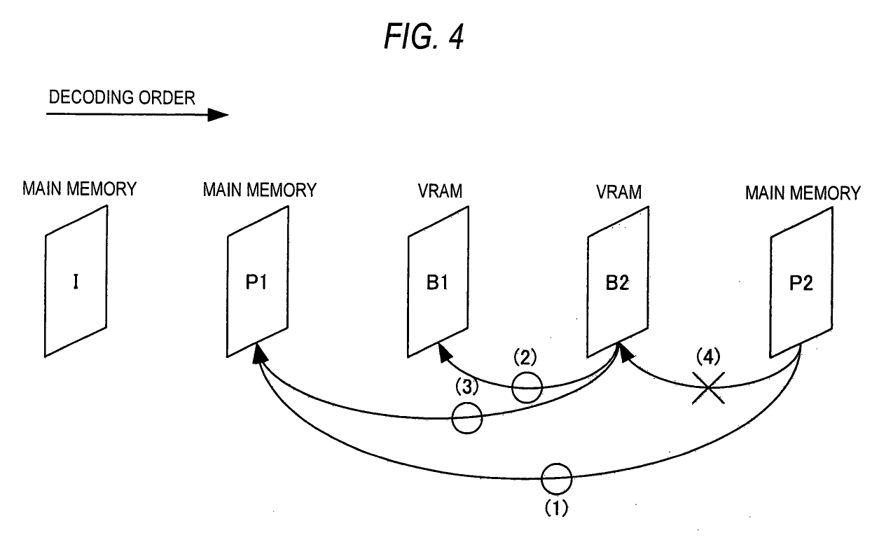

When a processor to be used is switched during the course of processing, a reference image must be present in a memory area available for a processor at the time of decoding of a picture requiring a reference. Decoding operation performed by the CPU 111 and the GPU 117 will be described by reference to FIG. 4.

In FIG. 4, an I picture, a P1 picture, and a P2 picture are decoded by means of the CPU 111, and a B1 picture and a B2 picture are decoded by the GPU 117. In this case, decoded images (corresponding to the output image signal 261) of the I picture, the P1 picture, and the P2 picture decoded by the CPU 111 are each generated in the main memory 115. Likewise, a decoded picture of the B1 picture and a decoded picture of the B2 picture, which have been decoded by the GPU 117, are each generated in the VRAM 118.

At this time, for instance, as indicated by reference numeral (1) in FIG. 4, the CPU 111 performs decoding, whereby a decoded picture P1 is generated on the main memory 115. No problems particularly arise in a case where the CPU 111 decodes the picture P2 that makes a reference to the image P1. Likewise, as designated by reference numeral 2 in FIG. 4, no problems arise in a case where a decoded picture of the B1 picture is generated in the VRAM 118 through decoding operation performed by the GPU 117 and where the GPU 117 decodes the picture B2 which makes a reference to the picture B1.

In addition, it may also be the case where, in a system in which a transfer rate achieved between the main memory 115 and the VRAM 118 is negligibly small, decoding can be performed without having awareness of memory to be used by means of transferring data pertaining to a decoded image.

For example, as indicated by reference numeral (3) in FIG. 4, in a case where the GPU 117 decodes the picture B2, even when the picture B2 is making a reference to the picture P1 in the main memory 115, the GPU 117 can decode the picture B2 by means of transferring the picture P1 in the main memory 115 to the VRAM 118.

However, for instance, in an environment, such as framework DirectX VA (hereinafter abbreviated also as “DXVA”) PROPOSED BY Microsoft Corporation, it may also be the case where transfer of data between the main memory 115 and the VRAM 118 takes much time.

For example, in the DXVA, a rate of transfer of data from the main memory 115 to the VRAM 118 is very small, whereas a rate of transfer of data from the VRAM 118 to the main memory 115 is large. In such a system, when the CPU 111 decodes the picture P2 as indicated by reference numeral 4 in FIG. 4 and when the picture P2 makes a reference to the picture B2 in the VRAM 118, data transfer involves consumption of much time, which in turn induces a delay in decoding operation.

In short, in such a situation, a processor available for referenced picture (the I picture, the P picture, or the referenced B picture) becomes different from a processor available for an unreferenced picture.

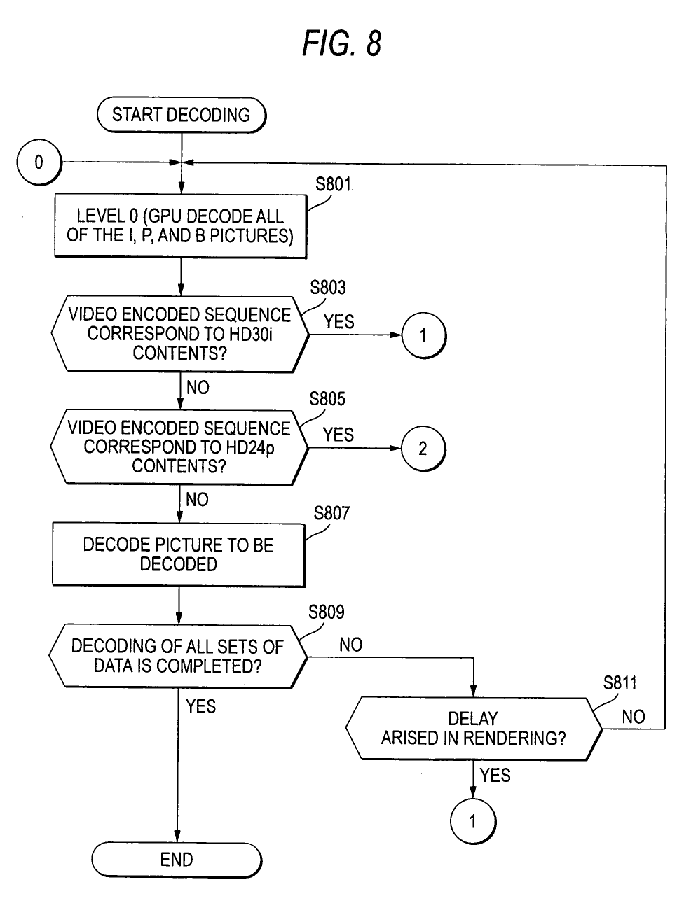

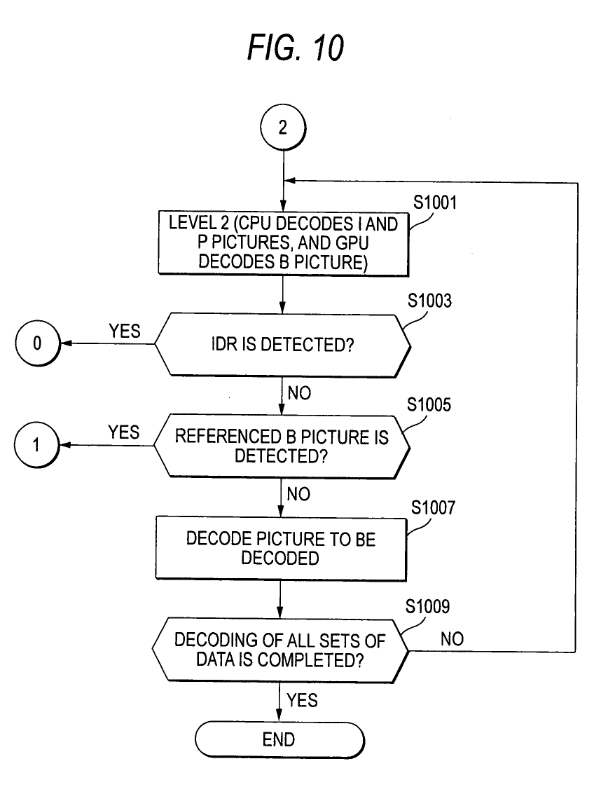

Accordingly, the computer 10 of the present embodiment switches decoding operation between the CPU 111 and the GPU 117 while avoiding occurrence of a case such as that indicated by reference numeral (4) in FIG. 4. Although details of processing will be described later by reference to flowcharts of FIGS. 8 through 10, the summary of processing is provided below.

The decoding program 20 of the present embodiment determines a processor which decodes a picture to be decoded in accordance with a mixture flag. Here, the mixture flag is for determining a processor used for a picture to be decoded. In the present embodiment, the mixture flag is assumed to determine the following three states.

Mixture Level 0: The GPU 117 decodes all pictures.

Mixture Level 1: The CPU 111 decodes the I picture, and GPU 117 decodes the P and B pictures.

Mixture Level 2: The CPU 111 decodes the I and P pictures, and the GPU 117 decodes the B picture.

According to the H.264 standard, taking the B picture as a referenced picture is allowed. Accordingly, in a case where decoding operation is progress in the state of Mixture Level 2, a state, such as that indicated by reference numeral (4) in FIG. 4, is achieved if the B picture is determined to be used as a referenced image in the middle of decoding operation, which may induce a delay. Therefore, when the picture to be decoded is a referenced B picture, the status proceeds to Mixture Level 1, and the GPU 117 decodes the B and P pictures included in a future video encoded sequence.

As described by reference to FIG. 3, the essential requirement for determining whether or not a picture to be decoded is a referenced picture is to ascertain that nal_ref_idc313 is nonzero. If nal_ref_idc313 is nonzero, the picture is a referenced picture.

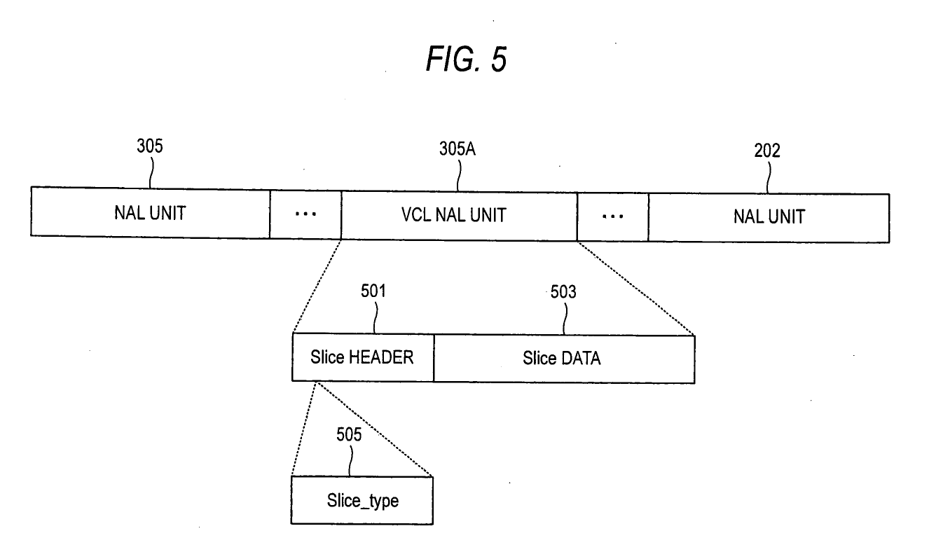

A method for determining whether or not a picture to be decoded is a B picture will now be described by reference to FIG. 5. As previously described by reference to FIG. 3, a plurality of NAL units 305 are stored in an access unit 303. A VCL NAL unit 305A which stores encoded video data belongs to the NAL units 305. Data pertaining to a slice which is a basic unit of H.264 encoding are stored in this VCL NAL unit 305A.

The VCL NAL unit 305A includes a slice header 501 and slice data 503. The slice header 501 includes slice_type 505, and a determination can be made as to whether or not the picture to be decoded is a B picture, by reference to slice_type 505.

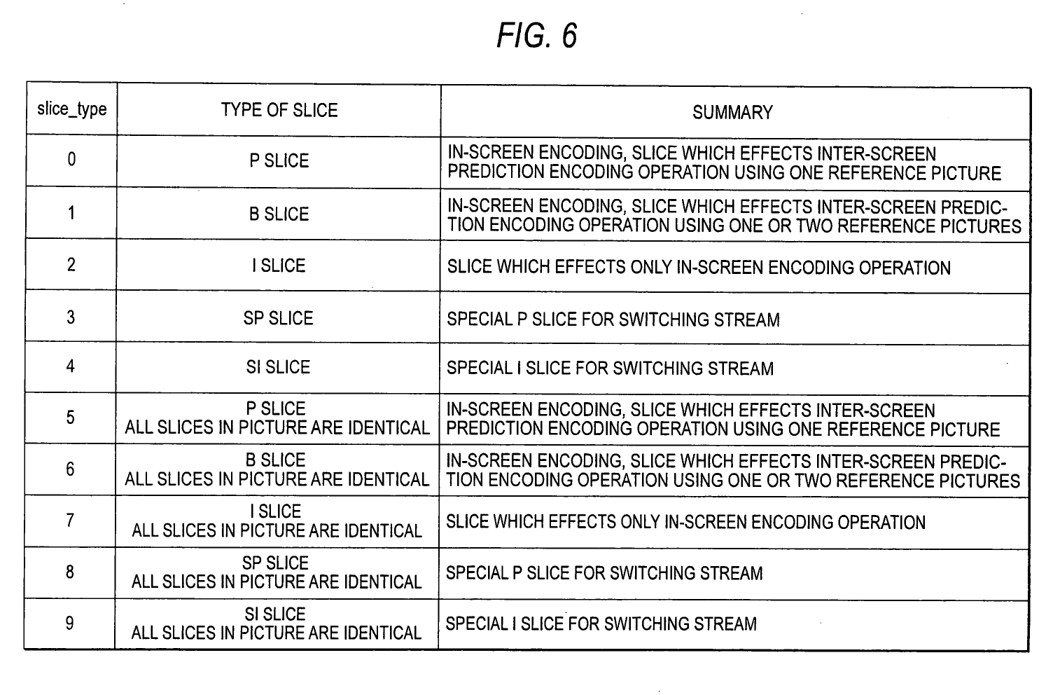

FIG. 6 shows a value which can be taken by slice_type 505. Ten types of values from 1 to 9 can be taken by slice_type 505. Value 0 and value 5 designate that a slice is a P slice. The P slice is for performing in-screen encoding operation and inter-screen prediction encoding using one referenced picture. The P slice can include two types of macro blocks I and P.

When slice_type 505 is value 1 or value 6, this indicates that the slice of interest is a B slice. The B slice is for performing in-screen encoding and inter-screen prediction encoding using one or two referenced pictures. The B slice can include three types of macro blocks I, P, and B.

When slice_type 505 is value 2 or value 7, this indicates that the slice of interest is an I slice. The I slice is for performing only in-screen encoding operation. The I slice can include only I as the type of a macro block.

When slice_type 505 is value 3 or value 8, this indicates that the slice of interest is an SP slice (S is an abbreviation of Switching). The SP slice is a special P slice for use in switching a stream.

When slice_type 505 is value 4 or value 9, this indicates that the slice of interest is an SI slice (S is an abbreviation of Switching). The SI slice is a special I slice for use in switching a stream.

When slice_type 505 is any one of values 5 through 9, this indicates that all of the slices falling within a picture including that slice are of the same slice type. In short, when slice_type assumes a value of 6, all of the slices falling within the picture are determined to be B slices. Hence, the picture to be decoded can be determined to be a B picture. When slice_type 505 assumes any of values 0 to 4, making a reference solely to slice_type 505 poses difficulty in determining which one of the I, P, and B pictures corresponds to the picture to be decoded. Therefore, in the case of such a picture, it is better to decode all of the pictures by means of the GPU 117 under the assumption of Mixture Level 0.

As in the case of; for instance, the HD DVD standard, in the case of the encoded video image sequence 251 that requires an access unit delimiter (hereinafter referred to also as an “AUD”) 305B as requisites, a reference is made to primary_pic_type 701 included in the access unit delimiter 305B, so that the type of a picture can be determined without ascertaining slice_type 505. The access unit delimiter 305 is an NAL unit 305 showing the top of the access unit 303.

Subsequently, the flow of decoding operation of the decoding program 20 is described by reference to FIGS. 8 through 10. FIG. 8 through 10 are flowcharts showing the flow of operation of the decoding program 20 for decoding the video encoded sequence 251.

Settings are made to Mixture Level 0 at a starting point of operation for decoding the video encoded sequence 251 (S801). As mentioned previously, Mixture Level 0 is a mode for decoding all of the I, P, and B pictures by means of the GPU 117.

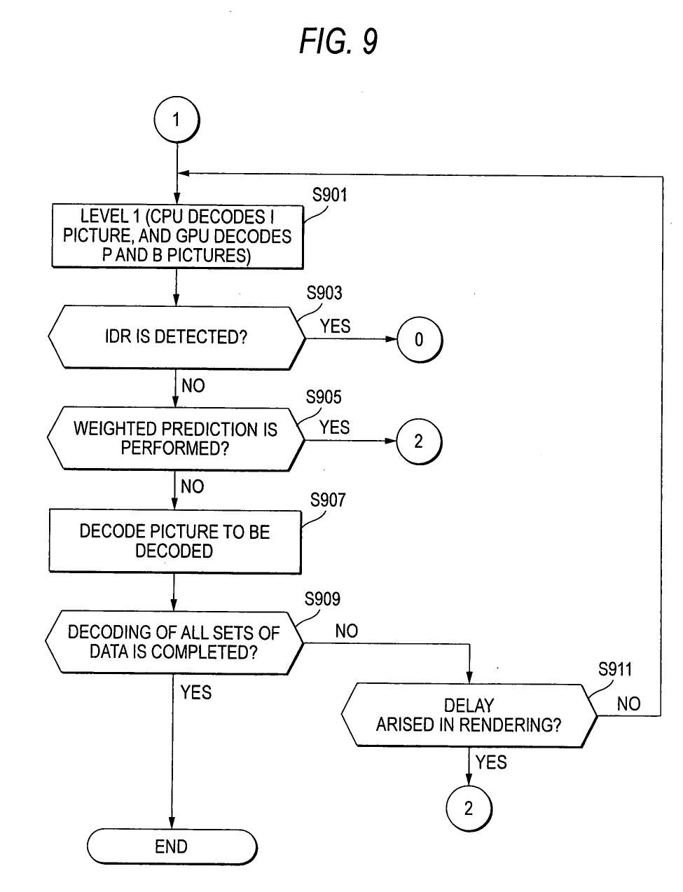

Subsequently, a determination is made as to whether or not the video encoded sequence 251 corresponds to 30i contents of HD size. The reason for this is that the GPU 117 processes an intra-macro block slowly. When the video encoded sequence 251 corresponds to 30i contents of HD size (Yes in S803), the status shifts to Mixture Level 1 where decoding operation of the CPU 111 is used in combination (S901 in FIG. 9).

When the video encoded sequence 251 does not correspond to 30i contents of HD size (No in S803), a determination is made as to whether or not the video encoded sequence 251 corresponds to 24p contents of HD size (S805). There may be the case where the GPU 117 decodes 24p contents of HD size slowly. When the video encoded sequence 251 corresponds to 24p contents of HD size (Yes in S805), the status shifts to Mixture Level 2 (S1001).

When the video encoded sequence 251 corresponds to neither 30i contents of HD size nor 24p contents of HD size (No in S805), a picture to be decoded is subjected to decoding in accordance with a mixture level (S807). Now, since the mixture level is set to 0, the GPU 117 performs decoding even when the picture to be decoded is any one of the I, P, and B pictures.

The decoding program 20 determines whether or not decoding of all pictures of the video encoded sequence 251 has been completed (S809). When processing of all of the pictures has been completed, decoding operation is completed.

When a yet-to-be decoded picture is still present in the video encoded sequence 251 (No in S809), a determination is made to as to whether or not a delay has arisen in rendering (S811). When a delay has not arisen (No in S811), decoding operation is continued while the status is maintained at Mixture Level 0 (S801). Meanwhile, when a delay has arisen in rendering, the status is set to Mixture Level 1 (S901).

As mentioned previously, Mixture Level 1 is a mode for decoding the I picture by means of the CPU 111 and decoding the P and B pictures by means of the GPU 117.

After setting of the status to Mixture Level 1, the decoding program 20 determines whether or not the picture to be decoded is an IDR (Instantaneous Decoding Refresh) picture (S903). The IDR picture is an I picture located at the top of the image sequence. The IDR picture is formed from an I slice or an SI slice. Upon detection of the IDR picture, all statuses required to decode a bit stream, such as information showing the status of the frame memory section 211 (picture buffer), a frame number, and an output sequence of a picture, and the like, are reset. When the IDR picture has been detected, all of the video signals 261 stored in the frame memory section 211 are discarded, and hence there is no necessity for concern for a reference relationship.

When the IDR picture has been detected (Yes in S903); namely, when the picture to be decoded is an IDR picture, there is the possibility of a change having arisen in specifics of the video encoded sequence 251. Hence, processing returns to S801, and setting of a mixture flag is performed again. A determination as to whether or not the picture to be decoded is an IDR picture can be determined by means of making a reference to nal_unit_type315 in the NAL header 307. When nal_unit_type315 assumes a value of 5, the picture to be decoded is an IDR picture.

When the picture to be decoded is not an IDR picture (No in S903), a determination is made as to whether or not weighted prediction is performed (S905). The reason for this is that it may be the case where the GPU 117 performs weighted prediction slowly. When weighted prediction is performed (Yes in S905), the status proceeds to Mixture Level 2 (S1001).

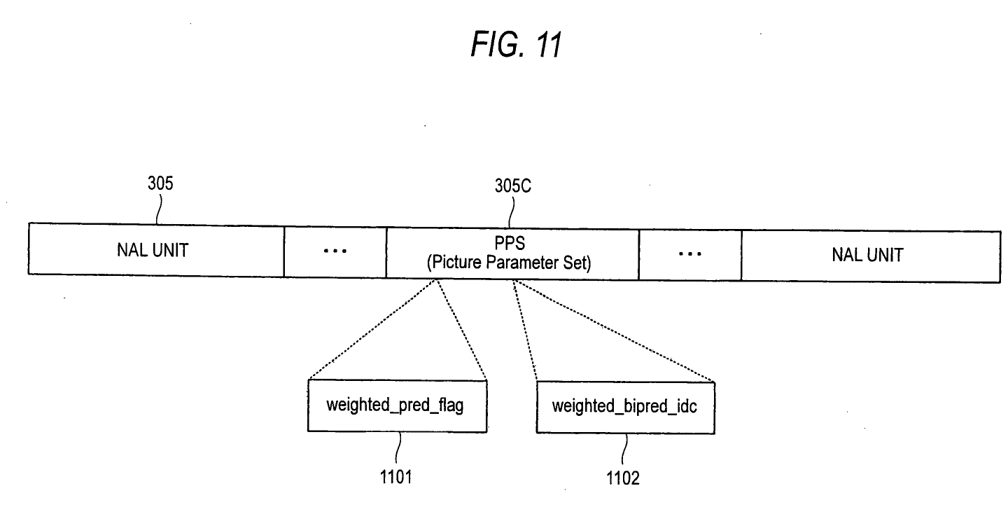

Weighted prediction is one encoding method conforming to H.264 in order to enhance efficiency of compression of a scene such as a fade-in of a scene, a fade-out of a scene, and the like. A determination as to whether or not weighted prediction is performed is determined by making a reference to weighted_pred_frag1101 and weighted_bipred_idc1102 in the PPS (Picture Parameter Set) 305C (see FIG. 11). In more detail, when weighted_pred_flag1101 assumes a value of 1, weighted prediction is understood to be used in connection with the P slice or the SP slice. When weighted_bipred_idc1102 assumes a value of 1, weighted prediction is understood to be applied to the B slice in an explicit mode.

Herein, PPS designated by reference numeral 305C corresponds to an NAL unit 305 including header information showing an encoding mode of the entire picture (a variable-length encoding mode, a quantization parameter initial value for each picture).

When weighted prediction is not performed (No in S905), processing for decoding a picture to be decoded is performed according to a mixture level (S907). Since the status is set to Mixture Level 1, the CPU 111 performs decoding when the picture to be decoded is an I picture. When the picture to be decoded in a P or B picture, the GPU 117 performs decoding.

Subsequently, the decoding program 20 determines whether or not decoding of all of the pictures of the video encoded sequence 251 has been completed (S809). When decoding of all of the pictures has been completed (Yes in S909), decoding operation is completed.

When a picture which has not yet been decoded still exists in the video encoded sequence 251 (No in S909), a determination is made as to whether or not a delay has arisen in rendering (S909). When no delay has arisen (No in S909), decoding operation is continued while Mixture Level 1 is maintained (S901). Meanwhile, when a delay has arisen in rendering, the status is set to Mixture Level 2 (S1001).

As mentioned previously, Mixture Level 2 is a mode for decoding I and P pictures by means of the CPU 111 and decoding the B picture by means of the GPU 117.

After the status has been set to Mixture Level 2, the decoding program 20 determines whether or not the picture to be decoded is an IDR picture (S1003). When an IDR picture has been detected (Yes in S1003), there is a possibility of a change having arisen in specifics of the video encoded sequence 251, and hence processing returns to S801, where setting of the mixture flag is again performed.

When the picture to be decoded is not an IDR picture (No in S1003), a determination is made as to whether or not the picture to be decoded is a referenced picture (S1005). As mentioned previously, a determination as to whether or not the picture to be decoded is a referenced picture can be rendered by means of detecting nal_ref_idc313. A determination as to whether or not the picture to be decoded is a B picture can be rendered by means of detecting slice_type 505 or primary_pic_type701.

When the picture to be decoded is a referenced B picture (Yes in S1005), the status is set to Mixture Level 1 (S901). When the P picture has been decoded by means of the CPU 111, there is a possibility of a reference being made to the referenced B picture as a referenced picture. As mentioned previously, the reason for this is that, when the picture is stored in the VRAM 118, making a reference to the referenced B picture causes a delay in decoding operation.

When the picture to be decoded is not the referenced B picture; namely, when the picture to be decoded is any one of the I picture, the P picture, and an unreferenced picture B, decoding is performed in accordance with the mixture flag. Since the mixture level is set to 2, the CPU 111 performs decoding when the picture to be decoded is an I picture or a P picture. The GPU 117 performs decoding when the picture to be decoded is a B picture.

Subsequently, the decoding program 20 determines whether or not decoding of all of the pictures of the video encoded sequence 251 is completed (S1009). After decoding of all of the pictures has been completed (Yes in S1009), decoding is completed. Since a picture which has not yet been decoded still exists in the video encoded sequence 251 (No in S1009), decoding is continued while Mixture Level 2 is maintained (S1001).

As described with reference to the embodiment, there is provided an information processing apparatus capable of preventing occurrence of a delay in decoding of a video.

What is claimed is:

1. An information processing apparatus for decoding a video encoded sequence,
wherein the video encoded sequence includes:
a first picture that is decodable without referring to other picture;
a second picture that is decodable by referring to one other picture; and
a third picture that is decodable by referring to a plurality of other pictures,
wherein the first picture includes a refresh first picture involving resetting of a buffer memory,
wherein the third picture includes a referenced third picture that is referred to by the second picture or the third picture and an unreferenced third picture that is referred to by none of other pictures,
wherein the information processing apparatus comprises:
a CPU that decodes the video encoded sequence by executing software;
a GPU that decodes the video encoded sequence;
a main memory that temporarily stores data for the decoding process performed by the CPU; and
a VRAM that temporarily stores data for the decoding process performed by the GPU,
wherein the GPU continues the decoding process of subsequent pictures of at least the second and third pictures after the GPU decoded the referenced third picture, until the refresh first picture is subjected to the decoding process.

2. The information processing apparatus according to claim 1, wherein the CPU performs the decoding process for at least the first picture when a predetermined amount of delay is occurred in the decoding process performed by the GPU.

3. The information processing apparatus according to claim 2, wherein the GPU performs the decoding process for the first picture, the second picture, and the third picture after the refresh first picture is detected to be subjected to the decoding process.

4. The information processing apparatus according to claim 1, wherein, when the decoding process for the second picture or the third picture involves weighted prediction, the CPU performs the decoding process for at least the second picture unless the referenced third picture or the refresh first picture is subjected to the decoding process.
